(19) United States
(12) Patent Application Publication
(10) Pub. No.: US 2019/0017318 A1
(43) Pub. Date: Jan. 17, 2019

(54) System and Method for Transport and Installation of a Screen Assembly

(71) Applicant: Centor Design Pty Ltd, Eagle Farm (AU)

(72) Inventors: Christopher Smith, Eagle Farm (AU); Martin Haberland, Eagle Farm (AU)

(73) Assignee: Centor Design Pty Ltd

(21) Appl. No.: 16/033,133

(22) Filed: Jul. 11, 2018

(30) Foreign Application Priority Data
Jul. 12, 2017 (AU) 2017902739

(51) Int. Cl. E06B 9/42; E06B 9/54

(52) U.S. Cl. CPC E06B 9/42; E06B 2009/543; E06B 9/54

(57) ABSTRACT

A screen assembly including a flexible screen having a first edge and a second edge, a substantially vertical supporting member about which the screen can be wound/unwound and to which the first edge of the screen is mounted, a drum associated with at least one end of the supporting member, at least one line member that can be wound onto and off the drum, and a first removable clip. The first removable clip including: a body portion defining an opening for receiving a portion of a supporting member and drum assembly, and an upwardly extending portion, wherein the upwardly extending portion is configured to hold the at least one line member relative to an external surface of the drum during transportation of the screen assembly or prior to operation of the screen assembly.

### TECHNICAL FIELD

The present invention relates generally to the field of extendable and retractable screens that can be used in a window or door cavity, or any other area which may benefit from the assembly and which contains a flexible sheet like member (for instance an insect screen) which can be pulled across the window or door cavity and particularly to a transportable screen assembly for mounting within a window or door frame.

### BACKGROUND

It is well known to provide a roll up, or retractable, screen assembly that can extend across a window or door. In most cases, a flexible screen can be wound about a wooden, metal or plastic rod or pole which is positioned in a substantially horizontal manner such that the screen assembly can be pulled up or pulled down in a vertical direction. A holland blind is an example of this type of screen assembly.

It is also known to provide a retractable screen assembly that can move in a horizontal direction across a window or door cavity, and with this type of assembly, the screen (for instance a mesh) can be wound about a substantially vertical rod or pole (typically located at one side of the cavity).

The present invention is directed primarily to a transportable screen assembly that can move horizontally across a window or door cavity when mounted thereto. However, there may be parts of the invention which may find suitability in up and down screens or screens which are extended and retracted in other manners.

One disadvantage of such horizontal screen assembles involves a drum around which a line member is wound and unwound. In particular, it is a known problem that the line member can fall from the drum, or become loose from the drum. This may occur at many stages, including during transportation of the screen assembly, prior to installation of the screen assembly or at any time that there is any slack in the line member. Once the line member falls from the drum or becomes loose from the drum, it is then extremely difficult to remount the line member correctly to the drum.

It will be clearly understood that, if a prior art publication is referred to herein, this reference does not constitute an admission that the publication forms part of the common general knowledge in the art in Australia or in any other country.

### DESCRIPTION OF INVENTION

The present invention is directed to a screen assembly, which may at least partially overcome the abovementioned disadvantage or provide the consumer with a useful or commercial choice.

With the foregoing in view, the present invention in one form, resides broadly in a screen assembly including:
a flexible screen having a first edge and a second edge,
a substantially vertical supporting member about which the screen can be wound/unwound and to which the first edge of the screen is mounted,
a drum associated with at least one end of the supporting member,
at least one line member that can be wound onto and off the drum, and
a first removable clip including:
   a body portion defining a channel for receiving a portion of the supporting member, and
   an upwardly extending portion,
      wherein the upwardly extending portion is configured to hold the at least one line member relative to an external surface of the drum during transportation or prior to operation of the screen assembly.

The present invention is particularly directed to a screen assembly as described above where the first removable clip prevents the at least one line member from unwinding from the drum during transportation and/or prior to operation of the screen assembly within an opening defined by a window or door frame.

As mentioned above, the first removable clip includes a body portion. The body portion may be any particular size or shape suitable for mounting to the supporting member or to a portion of a mounting assembly that is associated with the supporting member. In preferred embodiments, the shape of body portion substantially corresponds to the size and shape of a portion of the supporting member. In some embodiment, the shape of the body portion is substantially ring or annular shaped.

The body portion preferably includes at least one and preferably a pair of shaped arms defining an opening for allowing the supporting member to enter the channel defined by the body portion. The opening may be any particular size suitable for allowing the body portion to be received thereinto and in a particularly preferred embodiment, the at least one and preferred pair of arms are at least partially resilient to allow some temporary deformation or deflection outwardly during mounting to the supporting member and during removal from the supporting member, and which when attached to or relative to the supporting member, exerts a clamping force to resist accidental but not determined removal. The opening may be defined by a pair of ends. In preferred embodiments, each end is rounded in order to facilitate mounting the first removable clip relative to the supporting member.

The resilient body portion includes an inner surface for abutting an outer surface of the supporting member or a portion of a mounting assembly that is associated with the supporting member. The shape of the inner surface of the body portion may substantially correspond to at least a portion of an outer surface of the supporting member or to a portion of a mounting assembly that is associated with the supporting member. The body portion further includes an upper surface for abutting an outer surface of the drum, a bottom surface in particular. The shape of the upper surface of the body portion may substantially correspond to at least a portion of a bottom portion of the drum.

The body portion may include one or more recesses. In preferred embodiments, the body portion includes two recesses. However, a person skilled in the art would understand that the body portion may include any number of recesses suitable for obtaining the level of resilience required to mount the resilient body portion to the supporting member. The one or more recesses may extend from an inner surface of the resilient body portion and extend outwardly. Advantageously, the one or more recesses increase the resilience of the body portion or the arm(s).

The upwardly extending portion may extend from the body portion. In some embodiments, the upwardly extending portion may extend from an upper surface of the body portion. In alternative embodiments, the upwardly extending portion may extend from a side surface of the body portion. When mounted to the supporting member, the upwardly extending portion preferably extends in a direction away from the supporting member or screen and towards the drum.

The upwardly extending portion may be any particular size or shape so long as it is configured to prevent the at least one line member from falling from the drum or becoming loose. Preferably, however, the height of the upwardly extending portion corresponds substantially to the height of the drum.

The upwardly extending portion may extend on an angle. The angle may substantially correspond to an angled side surface of the drum. In some embodiments, the upwardly extending portion may extend inwardly. In some alternative embodiments, the upwardly extending portion may extend outwardly. A skilled person, however, would understand that the upwardly extending portion need not extend on an angle, particularly if the outer surface of the drum is vertical or substantially vertical (i.e. does not include an angled outer surface).

The upwardly extending portion may include an overhang portion. The overhang portion may extend inwardly toward a central axis defined by the body portion, above the opening in the body portion. In some embodiments, the overhang portion may extend from a free edge of the upwardly extending portion. In some embodiments, the overhang portion may extend and inner surface of the upwardly extending portion. The overhang portion may be configured to secure the upwardly extending portion relative to the drum in order to prevent at least one line member from falling from the drum or becoming loose.

The first removable clip may further include a second body portion for aiding in the mounting, removal or both the mounting and the removal, of the body portion to or from the supporting member. A person skilled in the art would understand that the second body portion may be in any particular form, for example, a hook or other means suitable for gripping or insertion of a tool to aid removal of the first removable clip from engagement with the supporting member and drum. In some embodiments, the second body portion may be in the form of a tab. The tab may include an aperture, one or more ridges or recesses, etc for aiding in gripping the tab.

It is preferred that the first removable clip of the present invention is substantially unitary and although any material may be used, a plastic or similar material is particularly preferred.

The screen may comprise a mesh screen, a reflective material, and insulating material, a see-through material, a dark material, combinations and the like. The screen may be made of any suitable material including woven or nonwoven fabrics, plastics, flexible metals (for instance aluminium foil), laminated materials, bonded materials, reinforced materials, and the like. The screen may be made of a single material, a combination of materials, may be made of a single sheets, or a plurality of sheets that are attached together, and it is not considered that any particular limitation should be placed on the invention by the selection of the screen type. There may be circumstances where the screen comprises a plurality of elongate members which may be somewhat rigid and which are foldably or hingedly attached to each other such that the screen can still be rolled.

The screen will typically extend across a window or door opening and will therefore have dimensions to suit. It is also envisaged that the screen may be used in any area which would benefit from such an assembly and not necessarily limited to a window or door opening. The screen will typically have a height of between 1-3 m, and may have a length of between 1-10 m and preferably between 1-5 m.

The screen assembly can function as an insect screen, a blind, an awning and the like.

The supporting member about which the screen is wound/unwound may comprise any suitable member such as a rod, a tube, and the like. The length of the supporting member will typically be dependent on the height of the cavity or opening, in which the assembly will be fitted and is expected that a suitable length will be between 1-3 m. The supporting member may be made of any suitable material such as plastic, wood, metal, composite materials and the like. The diameter of the supporting member can vary but it is expected that the diameter will be between 1-20 cm.

Although it is envisaged that the supporting member will be generally cylindrical, under some circumstances, the supporting member may have a polygonal cross-section such as rectangular, octagonal etc. It is envisaged that the supporting member will be made of a single length of material, although, if considered expedient, the supporting member may be made of a plurality of lengths which are connected together. It is also considered that supporting member may be extendable if desired (for instance telescopic). It is also considered that the term “supporting member” should include anything which can support the otherwise flexible screen material.

The substantially vertical supporting member will typically be elongate and preferably tubular with a hollow internal void, preferably extending over the length of the supporting member.

An annular boss or similar may be included above that portion of the supporting member about which the screen is wound and spaced from an underside of the drum, in order to receive the first removable clip between the end edge of the screen and the bottom surface of the drum.

The supporting member will preferably have a periphery which may include a spline mounting channel. The spline mounting channel is preferably an opening formed into one circumferential portion of the supporting member with a smaller entry opening in the external circumference of the supporting member and a larger spline mounting portion such that once the spline is mounted within the spline mounting portion, the spline cannot be removed through the entry opening and is inserted and withdrawn longitudinally. In use, the screen will normally have a loop or similar formed at one end to receive an elongate spline. The loop will normally be located within the spline mounting channel and the spline then passed into the loop in order to attach or mount the screen relative to the supporting member.

As mentioned above, the screen assembly includes a drum associated with at least one end of the supporting member. The drum may have a simple conical profile, or a more complicated profile which may have cone shaped portions which may diverge or converge, cylindrical portions, other shapes, combination of shapes and the like.

Typically, the drum will be attached to, or relative to one end of the supporting member, and it is preferred that the drum is attached to, or relative to an upper end of the supporting member. It is also preferred that the drum tapers outwardly from a narrower diameter furthest from the supporting member, to a larger diameter adjacent to the supporting member, although this can be reversed if desired.

The drum of the present invention is preferably frustoconical with one end of the drum being smaller in dimension than the opposite end of the drum, and a frustoconical external wall portion extending between the smaller end and the larger end, about which the at least one line member is wound.

The drum may be mounted relative to the supporting member by any suitable means know in the art. Preferably, the drum is mounted relative to the supporting member such that rotation of the supporting member causes rotation of the drum or vice versa.

It is preferred that the drum of the present invention is substantially unitary and although any material may be used, a plastic or similar material is particularly preferred.

Turning now to the line member, the line member may comprise any suitable material such as steel, plastic, composite materials and the like. It is envisaged that the line member will be substantially circular in cross-section although it is envisaged that the line member may also be substantially flat (e.g. a strip or strap), oval in cross-section and the like. The line member may comprise a wire, a “rope”, a laminate of material, a chain, a cable and the like. One end of the line member may be fixed to the drum. The line member may also comprise a “ball chain” which is a cord with balls attached at spaced apart intervals.

The screen assembly may further include a stile or drawbar to which the second edge of the screen is mounted and which a user can grasp or grip to draw the screen across the opening. The drawbar may be any particular size or shape. Preferably, however, the drawbar will extend along at least a portion of the second edge of the screen. In some embodiments, the drawbar will extend substantially along the full length of the second edge of the screen.

The screen assembly may further include a second removable clip. The second removable clip may be any removable screen clip known in the art suitable for fixing a drawbar relative to a screen wound about a supporting member. In preferred embodiments the second removable clip may include a resilient first body portion defining a first channel for receiving at least a portion of the supporting member, and a resilient second body portion defining a second channel for receiving at least a portion of the drawbar, wherein the first body portion is mountable relative to at least a portion of the supporting member and the second body portion is mountable relative to at least a portion of the drawbar such that the supporting member and the drawbar are held in a fixed relationship relative to one another.

The first body portion may be substantially similar in shape to at least a portion of an outer surface of the screen when wound about the substantially vertical supporting member. The first body portion may be substantially annular.

The first body portion may define a channel for receiving a portion of the substantially vertical supporting member and wound screen. The first body portion may define an opening for a portion of the substantially vertical supporting member and screen to enter the channel.

The second body portion may extend from a portion of the first body portion. The second body portion may be substantially similar in shape to at least a portion of an outer surface of the draw bar.

The second removable clip may further include one or more a structural support walls configured to prevent relative movement between the first body portion and the second body portion. The one or more a structural support walls may be any size or shape.

It is preferred that the second removable clip of the present invention is substantially unitary and although any material may be used, a plastic or similar material is particularly preferred.

According, to another aspect of the present invention, there is provided a method of installing a screen assembly, the method including:
a. positioning a screen assembly relative to a window or door frame defining an opening, the screen assembly including:
   i. a flexible screen having a first edge and a second edge,
   ii. a substantially vertical supporting member about which the screen can be wound/unwound and to which the first edge of the screen is mounted,
   iii. a drum associated with at least one end of the supporting member,
   iv. at least one line member that can be wound onto and off the drum,
   v. a drawbar to which the second edge of the screen is mounted,
   vi. a first removable clip including:
      A. a body portion defining a channel for receiving a portion of the supporting member, and
      B. an upwardly extending portion,
      wherein the upwardly extending portion is configured to hold the at least one line member relative to an external surface of the drum during transportation of the screen assembly; and,
   vii. a second removable clip including:
      A. a resilient first body portion defining a first channel for receiving at least a portion of the supporting member, and
      B. a resilient second body portion defining a second channel for receiving at least a portion of the drawbar,
      wherein the first body portion is mountable relative to at least a portion of the supporting member and the second body portion is mountable relative to at least a portion of the drawbar such that the supporting member and the drawbar are held in a fixed relationship relative to one another;
b. removing the first removable clip from engagement with the supporting member; and
c. removing the second removable clip from relative engagement with the supporting member.

A skilled person would understand that the features of this aspect of the invention may be as described above in relation to the first aspect of the invention.

According to another aspect of the present invention, there is provided a removable clip for a screen assembly including:
a flexible screen,
a substantially vertical supporting member about which the screen can be wound/unwound,
a drum associated with at least one end of the supporting member, and
at least one line member that can be wound onto and off the drum, the clip including:

a resilient body portion defining a channel for receiving a portion of the supporting member, and

an upwardly extending portion,

wherein the upwardly extending portion is configured to hold the at least one line member relative to an external surface of the drum during transportation of the screen assembly.

A skilled person would understand that the features of this aspect of the invention may be as described above in relation to the first aspect of the invention.

According, to another aspect of the present invention, there is provided a removable clip for a screen assembly including:
a flexible screen,
a substantially vertical supporting member about which the screen can be wound/unwound,
a drum associated with at least one end of the supporting member, and
at least one line member that can be wound onto and off the drum,

the clip including:

a resilient body portion defining an opening for receiving a portion of a supporting member and drum assembly, and

an upwardly extending portion,

wherein the upwardly extending portion is configured to hold the at least one line member relative to an external surface of the drum during transportation of the screen assembly.

A skilled person would understand that the features of this aspect of the invention may be as described above in relation to the first aspect of the invention.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the p01Invention in any way. The Detailed Description will make reference to a number of drawings as follows:

FIG. 1 is an exploded isometric view of a door or window frame and screen assembly according to a preferred embodiment of the present invention.

FIG. 2 is an isometric view of the screen assembly shown in FIG. 1.

FIG. 3 is an enlarged end view of a screen mounting tube, drum and retainer clip according to a preferred embodiment of the present invention.

FIG. 4 is a top view of the screen assembly without the line member according to a preferred embodiment of the present invention.

FIG. 5 shows the method of mounting a retainer clip relative to a screen mounting tube and drum.

FIGS. 6A-6C show various views of the screen installation clip shown in FIGS. 1 and 2.

FIGS. 7A-7F show various views of the retainer clip shown in FIGS. 1 and 2.

FIG. 8 is a schematic view of a single screen assembly according to a preferred embodiment of the present invention.

FIG. 9 is a schematic view of a double screen assembly according to a preferred embodiment of the present invention.

### DESCRIPTION OF EMBODIMENTS

According to a particularly preferred embodiment of the present invention, a screen assembly 10 and particularly a screen mounting assembly are provided.

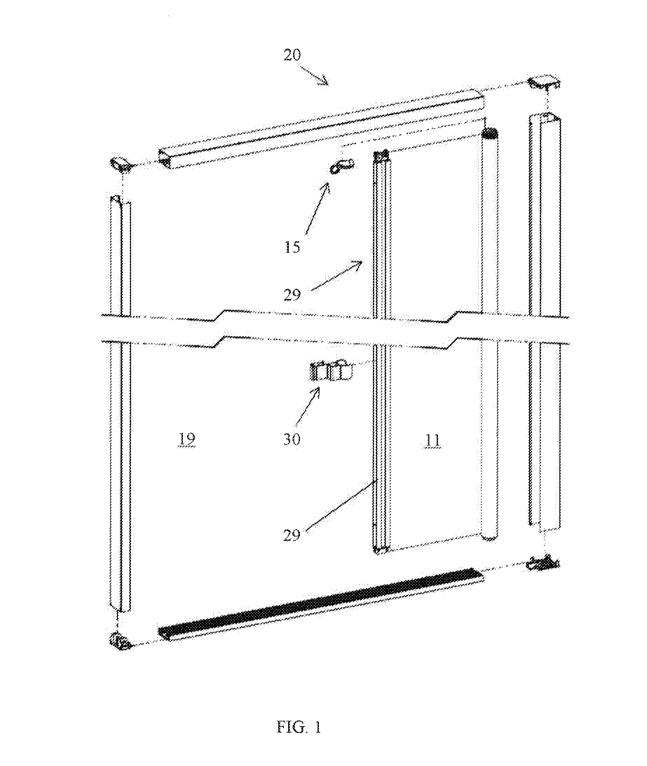

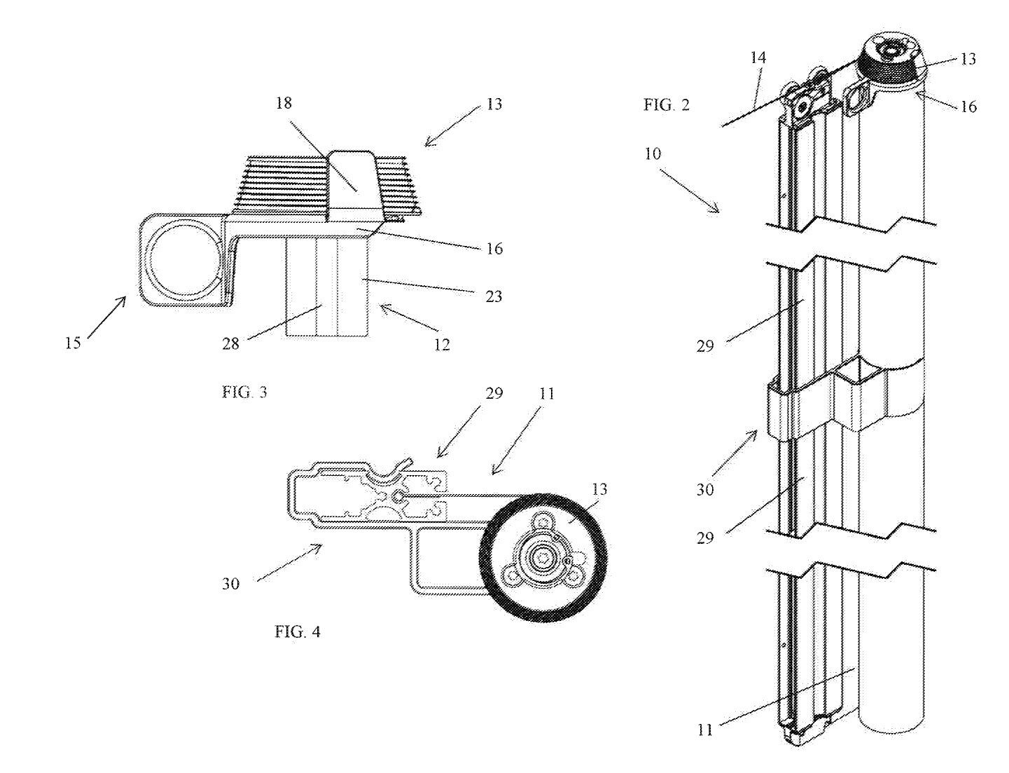

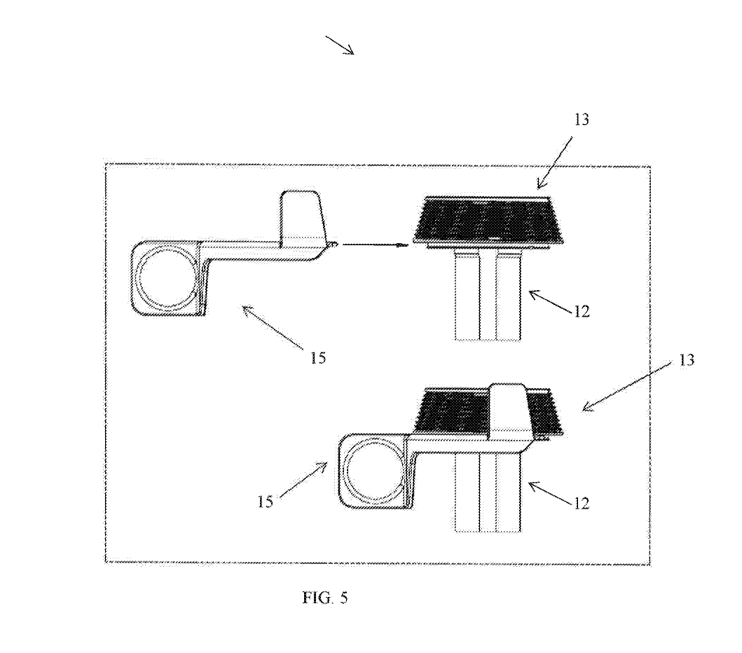

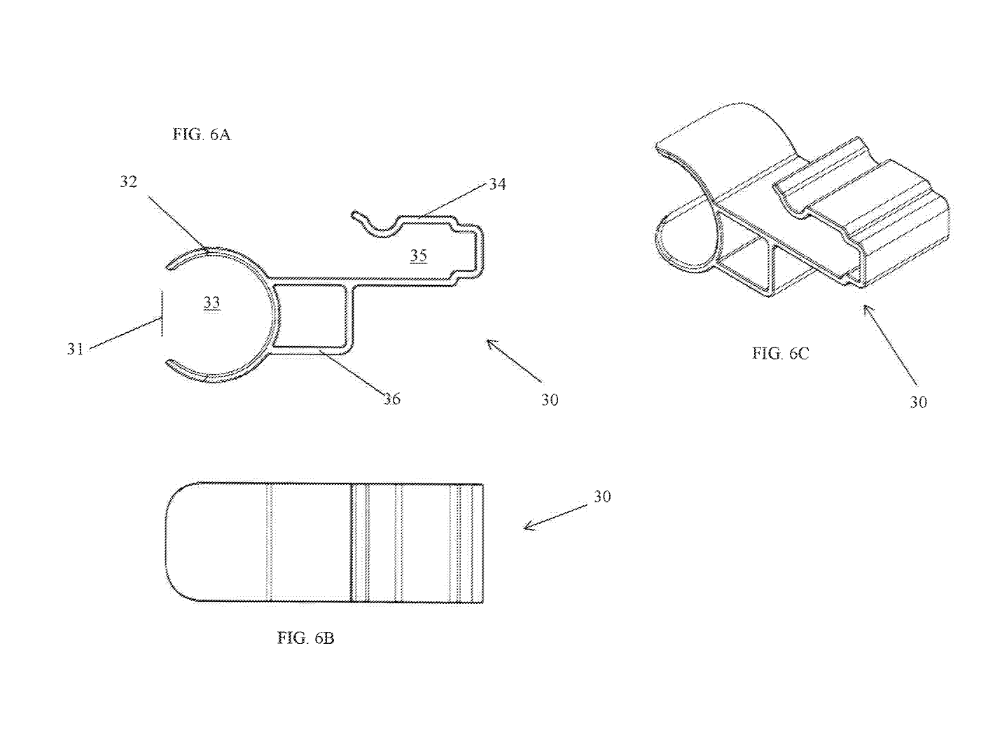

The screen assembly 10 of the illustrated embodiment (best illustrated in general in FIGS. 1 and 2) includes a flexible screen 11 having a first edge and a second edge, a substantially vertical supporting member 12 about which the screen can be wound/unwound and to which the first edge of the screen 11 is mounted, a drum 13 associated with at least one end of the supporting member 12, at least one line member 14 that can be wound onto and off the drum 13, and a first removable clip 15 including a resilient body portion 16 defining an opening 17 for receiving a portion of the supporting member 12, and an upwardly extending portion 18, wherein the upwardly extending portion 18 is configured to hold the at least one line member 14 relative to an external surface of the drum 13 during transportation or prior to instalment of the screen assembly.

The present invention is particularly directed to a screen assembly 10 as described above where the first removable clip 15 prevents the at least one line member 14 from unwinding from the drum 13 during transportation and/or prior to installation of the screen assembly 10 within an opening 19 defined by a window or door frame 20.

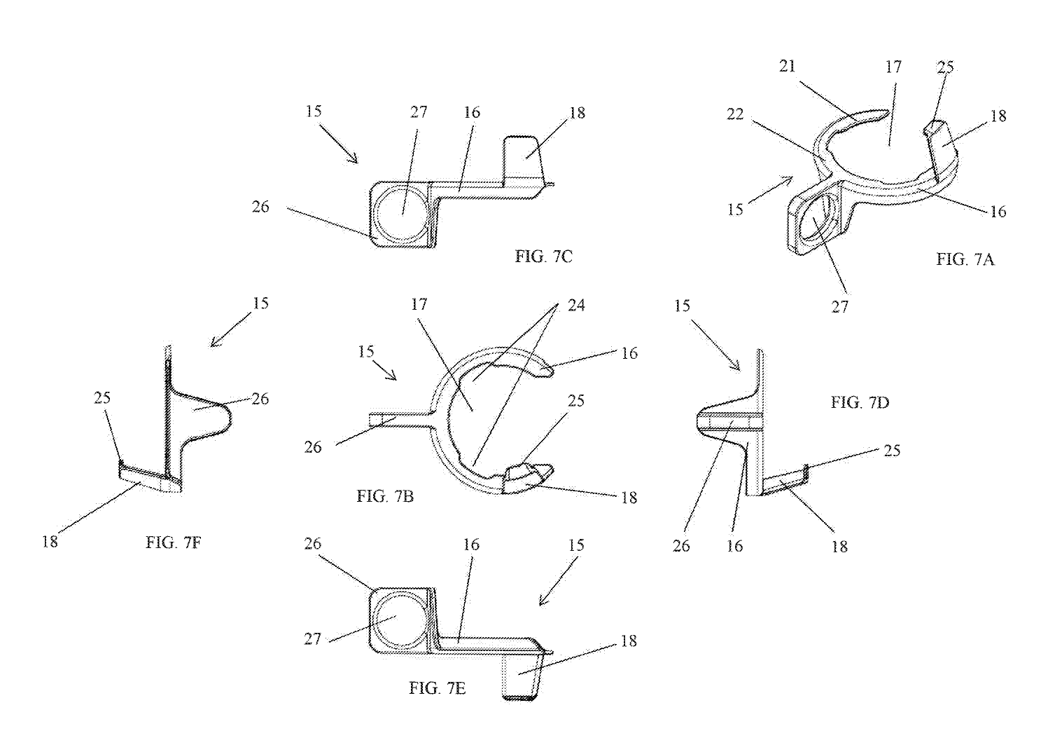

As mentioned above, first removable clip 15 includes resilient body portion 16. As best shown in FIGS. 7A-7F, resilient body portion 16 includes an inner surface 21 for abutting a portion of the supporting member 12 and an upper surface 22 for abutting a portion of a bottom surface of the drum 13. The shape of the inner surface 21 of the resilient body portion 16 substantially corresponds to a portion of an outer surface 23 of the supporting member 12. Furthermore, the shape of the upper surface 22 of the resilient body portion 12 substantially corresponds to at least a portion of a bottom surface of the drum 13.

As can be seen best in FIGS. 7A and 7B, the resilient body portion 16 is annular in shape.

The resilient body portion 16 defines an opening for allowing the supporting member 12 to enter opening 17 defined by the resilient body portion 16.

Resilient body portion 16 includes a pair of recesses 24.

As best shown in FIG. 7A, upwardly extending portion 18 extends from the resilient body portion 16. When mounted to the substantially vertical supporting member 12, upwardly extending portion 18 extends away from supporting member 12 (as shown best in FIG. 3). The height of the upwardly extending portion 18 corresponds substantially to the height of drum 13.

As best shown in FIGS. 7D and 7F, upwardly extending portion extends on an angle. The angle substantially corresponding to the side surface of the drum 13.

Turning back to FIGS. 7A, 7D and 7F, upwardly extending portion 18 includes overhang portion 25. Overhang portion 25 extends inwardly toward a central axis defined by resilient body portion 16. In the embodiment shown, the overhand portion 25 extends from a free edge of the upwardly extending portion 18. A skilled person, however, would understand that in some embodiments, overhang portion 25 may extend from an inner surface of the upwardly extending portion 18.

Together the resilient body portion 16 and the upwardly extending portion 18 mount the first removable clip 15 relative to the supporting member 12 and drum 13.

The first removable clip 15 further includes a second body portion 26 for aiding in the removal of the resilient body portion 16 from the supporting member 12. A person skilled in the art would understand that the second body portion 12 may be in any particular form, for example, a hook or other means suitable for gripping or insertion of a tool to aid removal of the first removable clip from engagement with the supporting member and drum. In the embodiment shown in FIGS. 7A-7F, the second body portion 26 is in the form of a tab. The tab includes an aperture 27.

As is shown in the Figures, the first removable clip 15 is substantially unitary and although any material may be used, a plastic or similar material is particularly preferred.

The screen 11 may comprise a mesh screen, a reflective material, and insulating material, a see-through material, a dark material, combinations and the like. The screen may be made of any suitable material including woven or nonwoven fabrics, plastics, flexible metals (for instance aluminium foil), laminated materials, bonded materials, reinforced materials, and the like. The screen may be made of a single material, a combination of materials, may be made of a single sheets, or a plurality of sheets that are attached together, and it is not considered that any particular limitation should be placed on the invention by the selection of the screen type. There may be circumstances where the screen comprises a plurality of elongate members which may be somewhat rigid and which are foldably or hingedly attached to each other such that the screen can still be rolled.

The screen 11 will typically extend across a window or door opening and will therefore have dimensions to suit. It is also envisaged that the screen 11 may be used in any area which would benefit from such an assembly and not necessarily limited to a window or door opening. The screen 11 will typically have a height of between 1-3 m, and may have a length of between 1-10 m and preferably between 1-5 m.

The screen assembly 10 can function as an insect screen, a blind, an awning and the like.

The length of the supporting member 12 will typically be dependent on the height of the cavity or opening, in which the assembly 10 will be fitted and is expected that a suitable length will be between 1-3 m. The supporting member 12 may be made of any suitable material such as plastic, wood, metal, composite materials and the like. The diameter of the supporting member can vary but it is expected that the diameter will be between 1-20 cm.

Although it is envisaged that the supporting member 12 will be generally cylindrical, under some circumstances (as shown in the present drawings), the supporting member may have a polygonal cross-section such as rectangular, octagonal etc in other embodiment. It is envisaged that the supporting member will be made of a single length of material, although, if considered expedient, the supporting member may be made of a plurality of lengths which are connected together.

The supporting member 12 will preferably have a periphery which may include a spline mounting channel 28. The spline mounting channel 28 is an opening formed into one circumferential portion of the supporting member 12 with a smaller entry opening in the external circumference of the supporting member 12 and a larger spline mounting portion such that once the spline is mounted within the spline mounting portion, the spline cannot be removed through the entry opening and is inserted and withdrawn longitudinally. In use, the screen will normally have a loop or similar formed at one end to receive an elongate spline. The loop will normally be located within the spline mounting channel and the spline then passed into the loop in order to attach or mount the screen relative to the supporting member 12.

As mentioned above, screen assembly 10 includes a drum 13 associated with at least one end of the supporting member 12. The drum 13 has a simple frustoconical profile with one end of the drum being smaller in dimension than the opposite end of the drum, and a frustoconical external wall portion extending between the smaller end and the larger end, about which the at least one line member is wound.

Drum 13 is attached to, or relative to an upper end of the supporting member 12. Drum 13 tapers outwardly from a narrower diameter furthest from the supporting member 12, to a larger diameter adjacent to the supporting member 12. In alternative embodiments (not shown), this can be reversed if desired.

Drum 13 may be mounted relative to the supporting member by any suitable means known in the art.

Drum 13 of the illustrated embodiment is substantially unitary and although any material may be used, a plastic or similar material is particularly preferred.

The line member 14 may comprise any suitable material such as steel, plastic, composite materials and the like. It is envisaged that the line member 14 will be substantially circular in cross-section although it is envisaged that the line member may also be substantially flat (e.g. a strip or strap), oval in cross-section and the like. The line member may comprise a wire, a “rope”, a laminate of material, a chain, a cable and the like. One end of the line member may be fixed to the drum. The line member may also comprise a “ball chain” which is a cord with balls attached at spaced apart intervals.

The screen assembly may further include a drawbar 29 to which the second edge of the screen 11 is mounted. The drawbar 29 may be any particular size or shape. As best shown in FIG. 2, the drawbar 29 extends along the second edge.

The screen assembly 10 may further include a second removable clip 30. The second removable clip 30 may be any removable screen clip known in the art suitable for fixing a drawbar relative to a screen wound about a supporting member.

In the illustrated embodiment, the second removable clip 30 includes a resilient first body portion 32 defining a first opening 33 for receiving at least a portion of the supporting member 12, and a resilient second body portion 34 defining a second opening 35 for receiving at least a portion of the drawbar 29, wherein the first body portion 32 is mountable relative to at least a portion of the supporting member 12 and the second body portion 34 is mountable relative to at least a portion of the drawbar 29 such that the supporting member 12 and the drawbar 29 are held in a fixed relationship relative to one another.

The first body portion 32 is substantially similar in shape to at least a portion of an outer surface of the screen when wound about the substantially vertical supporting member. The first body portion is substantially annular.

The first body portion may define an opening 31 for a portion of the substantially vertical supporting member 12 and screen 11 to enter the opening 33.

The second body portion 34 may extend from a portion of the first body portion 32. The second body portion 34 may be substantially similar in shape to at least a portion of an outer surface of the draw bar 29.

Second removable clip 30 further includes one or more a structural support walls 36 for preventing movement of the first body portion 32 towards the second body portion 34.

It is preferred that the second removable clip 30 of the present invention is substantially unitary and although any material may be used, a plastic or similar material is particularly preferred.

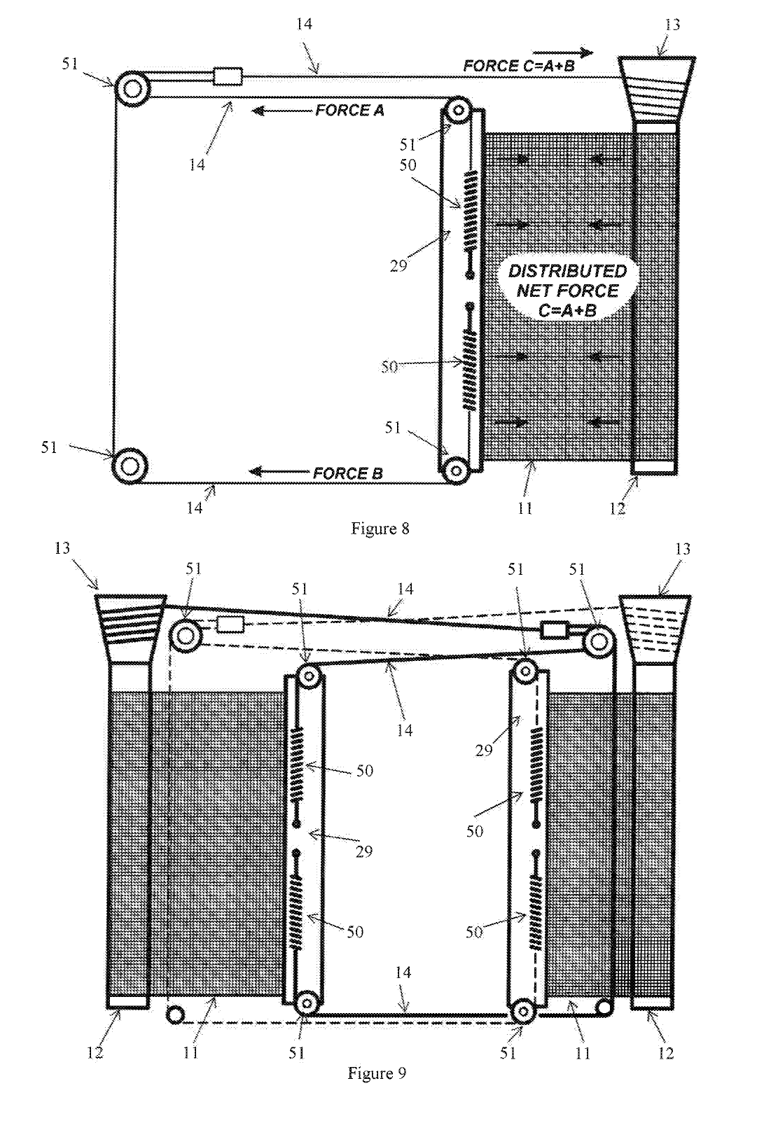

The screen assembly 10 of the illustrated embodiment (best illustrated in general in FIGS. 8 and 9) includes a flexible screen 11, a substantially vertical supporting member 12 about which the screen 11 can be wound/unwound and has an upper end and a lower end, at least one biasing spring 50 to create a tension in the screen 11, a drum 13 associated with at least one end of the supporting member 12, at least one line member 14 that can be wound onto and off the drum 13, the line member 14 being operatively associated with the screen 11 such that as the screen 11 is extended, the line member 14 is wound onto the drum 13, and as the screen 11 is retracted, the line member 14 is wound off the drum 13, the screen 11, when wound about the supporting member 12 having a diameter which increases as the screen 11 is wound about supporting member 12, and which decreases as the screen 11 is unwound from the supporting member 12.

The present invention is particularly directed to a screen assembly as described above where the flexible sheet-like screen 11 is wound about a supporting member 12 or tube (for example), and where the supporting member 12 is positioned substantially vertically such that the screen 11 extends and retracts in a horizontal direction as illustrated in FIGS. 8 and 9 in particular.

A feature of the screen assembly is to “tune” the drum diameter to be about the same as the diameter of the screen about the supporting member. Thus, as the screen is unwound, and the diameter decreases, the diameter of the drum, where the line member is wound onto the drum also decreases, to be about the same diameter. Conversely, as the screen is wound back onto the supporting member, and the diameter increases, the diameter of the drum where the line member is unwound from the drum also increases.

This particular feature enables the screen to be “balanced” at almost every point of extension and retraction which means that a person feels no resistance from the mesh tension at any position during operation of the unit. It also enables the screen material to have considerable tension to minimise sagging.

By “tuning” the diameter of the drum line to the diameter of the screen/supporting member, the forces seem to be quite balanced which means that it is relatively easy to pull the screen across the cavity without feeling an increased pullback force from the spring, and if the screen is let go, it will stay in position or possibly move only quite slowly.

One way by which the “tuning” can be achieved is to have a drum which has a conical shape, or where part of the drum has a conical shape, such that as the line member is wound onto, or off the drum, the diameter at the position where the line member contacts to drum will vary, and by designing a conical shape with regard to the diameter of the retracted screen, it is possible to have the two diameters to be approximately the same at all times.

The main purpose of the first removable clip 15 is to hold the line member 14 in the correct place on the drum 13 until the line member 14 is threaded through the pulleys 51 and tensioned by the springs 50. Once the line member 14 is tensioned, it resists falling off the drum 13 and the first removable clip 15 can be removed. If the first removable clip 15 is not present the line member 14 can still be tensioned but has a very high chance of being in the wrong position on the drum 13 which will result in unbalance mechanism that will prevent the screen stile or drawbar 29 from staying where it is placed.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A screen assembly including:
a flexible screen having a first edge and a second edge,
a substantially vertical supporting member about which the screen can be wound/unwound and to which the first edge of the screen is mounted,
a drum associated with at least one end of the supporting member,
at least one line member that can be wound onto and off the drum, and
a first removable clip including:
a body portion defining an opening for receiving a portion of a supporting member and drum assembly, and
an upwardly extending portion,
wherein the upwardly extending portion is configured to hold the at least one line member relative to an external surface of the drum during transportation of the screen assembly or prior to operation of the screen assembly.

2. The screen assembly as claimed in claim 1, wherein the body portion includes an inner surface for abutting an outer surface of a mounting assembly.

3. The screen assembly as claimed in claim 2, wherein the mounting assembly includes the supporting member.

4. The screen assembly as claimed in claim 2, wherein the shape of the inner surface of the body portion corresponds to a portion of a mounting assembly.

5. The screen assembly as claimed in claim 1, wherein the body portion is annular.

6. The screen assembly as claimed in claim, 1 wherein the body portion includes a pair of shaped arms defining an opening for allowing the supporting member to enter the channel defined by the body portion.

7. The screen assembly as claimed in claim 6, wherein the pair of arms are at least partially resilient to allow temporary outwardly deflection during mounting to the supporting member and during removal from the supporting member, and which when attached at least relative to the supporting member, exerts a clamping force to resist accidental but not determined removal.

8. The screen assembly as claimed in claim 1, wherein the body portion further includes an upper surface for abutting an outer surface of the drum.

9. The screen assembly as claimed in claim 8, wherein the outer surface of the drum is a bottom surface.

10. The screen assembly as claimed in claim 1, wherein the body portion further includes one or more recesses that extend from an inner surface of the resilient body portion and extend outwardly.

11. The screen assembly as claimed in claim 1, wherein the upwardly extending portion extends from the body portion.

12. The screen assembly as claimed in claim 1, wherein the upwardly extending portion extends towards an upper surface of the drum.

13. The screen assembly as claimed claim 1, wherein the upwardly extending portion extends on an angle.

14. The screen assembly as claimed in claim 1, wherein the upwardly extending portion further includes an overhang portion.

15. The screen assembly as claimed in claim 14, wherein the overhang portion extends inwardly toward a central axis defined by the body portion above the opening in the body portion.

16. The screen assembly as claimed in claim 14, wherein the overhang portion is configured to secure the upwardly extending portion relative to the drum in order to prevent the at least one line member from falling from the drum or becoming loose.

17. The screen assembly as claimed in claim 1, wherein the first removeable clip further includes a second body portion for aiding in the mounting, removal or both the mounting and the removal of the body portion to or from the supporting member.

18. The screen assembly as claimed in claim 1, further including a drawbar to which the second edge of the screen is mounted, and a second removable clip including:
a first body portion defining a first opening for receiving at least a portion of the supporting member, and
a second body portion defining a second opening for receiving at least a portion of the drawbar,
wherein the first body portion is mountable relative to at least a portion of the supporting member and the second body portion is mountable relative to at least a portion of the drawbar such that the supporting member and the drawbar are held in a fixed relationship relative to one another.

19. The screen assembly as claimed in claim 17, wherein the second removable clip further includes one or more a structural support walls configured to prevent relative movement between the first body portion and the second body portion of the second removable clip.

20. A method of installing a screen assembly, the method including:
a. positioning a screen assembly relative to a window or door frame defining an opening, the screen assembly including:
i. a flexible screen having a first edge and a second edge,
ii. a substantially vertical supporting member about which the screen can be wound/unwound and to which the first edge of the screen is mounted,
iii. a drum associated with at least one end of the supporting member,
iv. at least one line member that can be wound onto and off the drum,
v. a drawbar to which the second edge of the screen is mounted,
vi. a first removable clip including:
A. a body portion defining a opening for receiving a portion of a supporting member and drum assembly, and
B. an upwardly extending portion,
wherein the upwardly extending portion is configured to hold the at least one line member relative to an external surface of the drum during transportation of the screen assembly or prior to operation of the screen assembly; and,
vii. a second removable clip including:
C. a first body portion defining a first opening for receiving at least a portion of the supporting member, and
D. a second body portion defining a second opening for receiving at least a portion of the drawbar,
wherein the first body portion is mountable relative to at least a portion of the supporting member and the second body portion is mountable relative to at least a portion of the drawbar such that the supporting member and the drawbar are held in a fixed relationship relative to one another;
b. removing the first removable clip from engagement with the supporting member; and
c. removing the second removable clip from relative engagement with the supporting member.

21. A removable clip for a screen assembly including:
a flexible screen,
a substantially vertical supporting member about which the screen can be wound/unwound,
a drum associated with at least one end of the supporting member, and
at least one line member that can be wound onto and off the drum,
the clip including:
a body portion defining an opening for receiving a portion of a supporting member and drum assembly, and
an upwardly extending portion configured to hold the at least one line member relative to an external surface of the drum.
